(19) United States
(12) Patent Application Publication
(10) Pub. No.: US 2011/0141563 A1
(43) Pub. Date: Jun. 16, 2011

(54) REFLECTIVE STRUCTURE

(75) Inventor: Jin Can Wang, Xinzhuang City (TW)

(73) Assignee: Shih Yu Chen, Luzhou City (TW)

(21) Appl. No.: 12/638,988

(22) Filed: Dec. 16, 2009

(51) Int. Cl. G02B 5/136

(52) U.S. Cl. 359/546

(57) ABSTRACT

An improved reflective structure utilizing a water transfer printing means for adhesion onto an object in a detachable/non-detachable manner includes a substrate, an isolation layer, an ink layer and a cover layer. The substrate is used for adhesion onto an object, and the isolation layer (an essential oil) is disposed over the substrate and dissolvable in water such that the thickness of the entire structure is reduced. The ink layer has a high polymer content and is printed onto the surface of the isolation layer to provide different patterns. The glass bead layer is capable of reflecting light and is disposed onto the ink layer surface. The cover layer is disposed over the surface of the glass bead layer. Alternatively, the glass bead layer is disposed over the cover layer, and the cover layer is disposed on the ink layer, so that the reflective structure is flexible for complicated, curved shapes.

### BACKGROUND OF THE INVENTION

1. Field of the Invention

The present invention relates to an improved reflective structure, and more particularly to an improved reflective structure utilizing a water transfer printing means for adhesion onto an object.

2. Description of the Related Art

Currently, people are becoming increasingly aware of the importance of good health, and so more and more exercise equipment is becoming available, such as bicycles. People enjoy riding bicycles for both exercise and relaxation. In order to improve the safety of the rider at night, most riders purchase an illumination warming device or reflective strips, stickers or similar devices for the bicycle. However, these illumination warming devices and reflective devices all need to be installed on the bicycle frame, and they are relatively expensive and easily stolen due to their simple installation procedures.

Reflective strips and stickers are relatively cheaper and so are less likely to be stolen. The prior art reflective strip or sticker usually has a certain thickness, and tends to peel off after a period of time. Moreover, these reflective strips and stickers are suitable for only certain areas on the bicycle, which may not provide the desired effect.

Therefore, it is desirable to provide an improved reflective structure to mitigate and/or obviate the aforementioned problems.

### SUMMARY OF THE INVENTION

An objective of the present invention is to provide an improved reflective structure.

Another objective of the present invention is to provide an improved reflective structure that is relatively thinner and capable of covering the entire object surface for better reflection effects.

Another objective of the present invention is to provide an improved reflective structure that can improve the safety of the bicycle for riders at night.

In order to achieve the above-mentioned objectives an improved reflective structure utilizing a water transfer printing means for adhesion onto an object in a detachable/non-detachable manner is disclosed. The structure has a substrate, an isolation layer, an ink layer and a cover layer. The substrate is used for adhesion onto an object, and the isolation layer (an essential oil) is disposed over the substrate and dissolvable in water such that the thickness of the entire structure is reduced. The ink layer has a high polymer content and is printed onto the surface of the isolation layer to provide different patterns. A glass bead layer is capable of reflecting light and is disposed onto the ink layer surface. The cover layer is disposed over the surface of the glass bead layer and detachable from the glass bead layer. Therefore, the substrate is capable of being adhered onto an object having a small, curved surface and has a relatively thinner structural thickness.

Alternatively, the glass bead layer may be disposed over the cover layer, and the cover layer may be disposed on the ink layer, so the reflective structure is flexible for complex, curved shapes. Therefore, due to the flexibility of the cover layer provided to the ink layer, the substrate is capable of being deformed to match complicated curved surfaces on an object.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a detachable film being removed according to an embodiment of the present invention.

FIG. 2 is a state drawing showing when the detachable film is just applied and the essential oil is not yet dissolved according to an embodiment of the present invention.

FIG. 3 is a state drawing showing when the essential oil has dissolved according to an embodiment of the present invention.

FIG. 4 is a structural schematic drawing of a non-detachable reflective film according to another embodiment of the present invention.

FIG. 5 is a state drawing showing when the non-detachable reflective film has just been applied and the essential oil has not yet dissolved according to the present invention.

FIG. 6 is a state drawing showing when the non-detachable reflective film has just been applied and the essential oil has dissolved according to the present invention.

### DETAILED DESCRIPTION OF THE PREFERRED EMBODIMENT

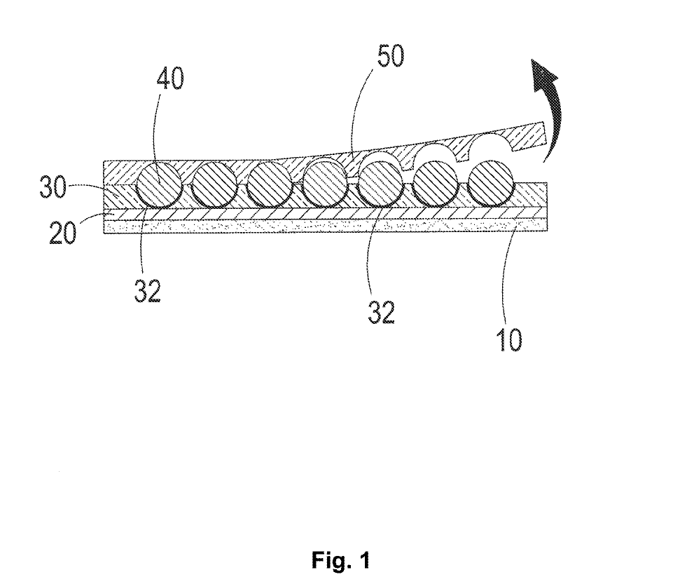

Please refer to FIG. 1. FIG. 1 is a schematic drawing of a detachable film being removed according to an embodiment of the present invention. As shown in the drawing, the present invention utilizes a water transfer printing means to provide a detachable film capable of being adhered onto an object. A substrate 10 is used as an adhesive surface for application onto the object. An isolation layer 20 (an essential oil) is disposed over the substrate 10 separated from the object and dissolvable in water. An ink layer 30 has a high polymer content and is printed onto the surface of the isolation layer 20. A cross-linking agent 32 is used as a medium to cover the ink layer 30 by way of a glass bead layer 40, which is capable of reflecting light and is disposed onto the ink layer surface 30. The ink layer 30 includes inks having different colors for a look with more variety. A cover layer 50 is disposed over the surface of the glass bead layer 40, and the cover layer 50 is insoluble in water and detachable from the glass bead layer 40. Therefore, the substrate 10 is capable of being adhered onto an object having a small, curved surface by way of a water transfer printing means.

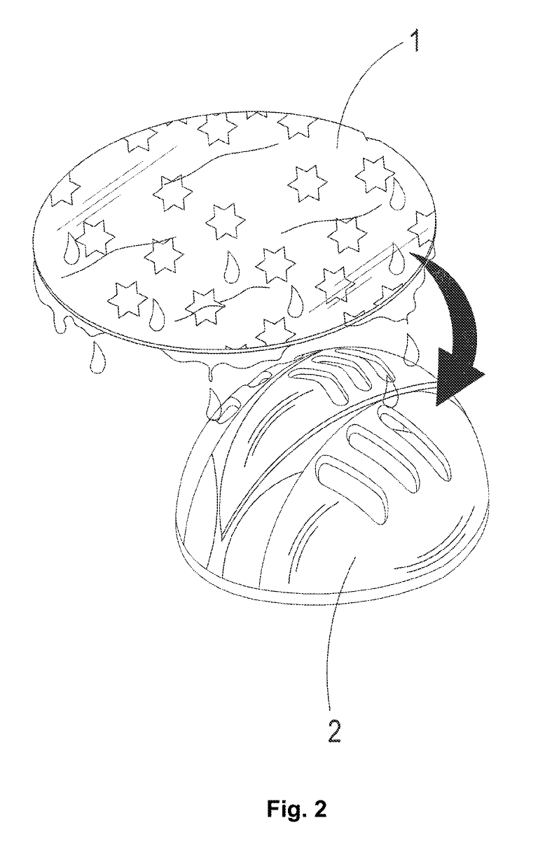

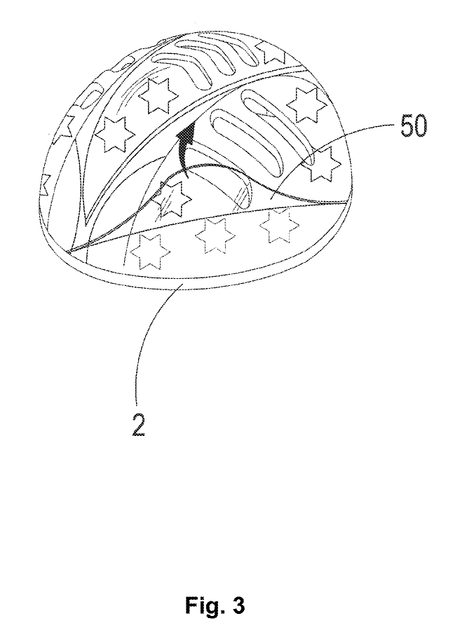

Please refer to FIG. 2 and FIG. 3. FIG. 2 is a state drawing showing when the detachable reflective structure has just been applied and the essential oil has not yet dissolved according to an embodiment of the present invention. FIG. 3 is a state drawing showing when the essential oil has dissolved according to an embodiment of the present invention. Taking a typical safety helmet 2 as an example object having a small, curved surface, when a user wants to apply the detachable reflective layer 11 onto the surface of safety helmet 2, he or she wets the substrate 10 with water and applies it onto the safety helmet 2 surface. Subsequently, the isolation layer 20 (the essential oil) is dissolved into the water and then evaporates with the water. When the detachable reflective layer 11 is placed correctly, the very outside cover layer 50 is torn off along the surface of safety helmet 2. Since the cover layer 50 is made of a material (such as resin) that insoluble in the ink layer 30, when the cover layer 50 is torn off there will be no residue left on the ink layer 30.

The glass bead layer 40 disposed over the ink layer 30, and when light shines onto the glass bead layer 40, a reflective effect is generated to improve nighttime safety for the user. In addition, since the ink layer 30 may include inks with different colors corresponding to different figures, the visual appearance of the safety helmet 2 in daytime may also be improved.

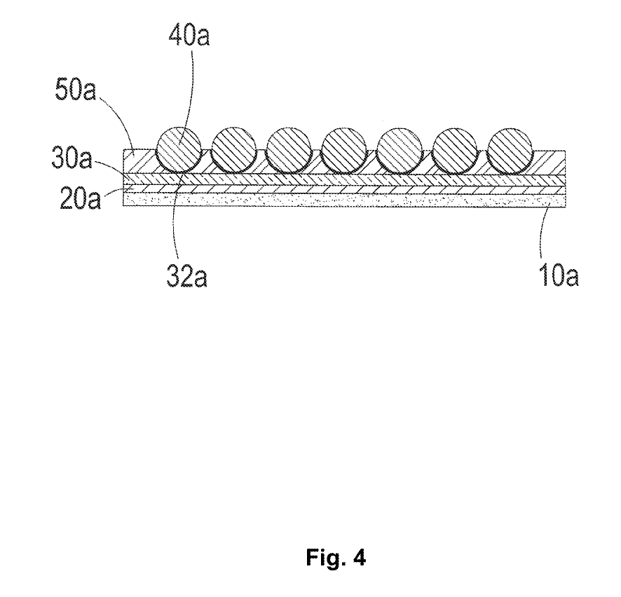

Please refer to FIG. 4. FIG. 4 is a structural schematic drawing of a non-detachable reflective structure according to another embodiment of the present invention. As shown in FIG. 4, the reflective film utilizes a water transfer printing means for adhesion onto an object in a non-detachable manner. A substrate 10a is used as an adhesive surface for application onto the object. An isolation layer 20a (essential oil) is disposed over the substrate 10a separated from the object and dissolvable in water. An ink layer 30a having a high polymer content is printed onto the surface of the isolation layer 20a. The ink layer 30a includes inks having different colors for a more varied look. A cover layer 50a is disposed over the surface of the ink layer 30a, and the cover layer 50a may be a resin material that is insoluble in the ink layer 30a. A cross-linking agent 32a is used as a medium to cover the cover layer 50 by way of a glass bead layer 40a. Therefore, due to the flexibility of the cover layer 50a provided to the ink layer 30a, the substrate 10a is capable of being deformed to match any complicated curved surfaces on an object.

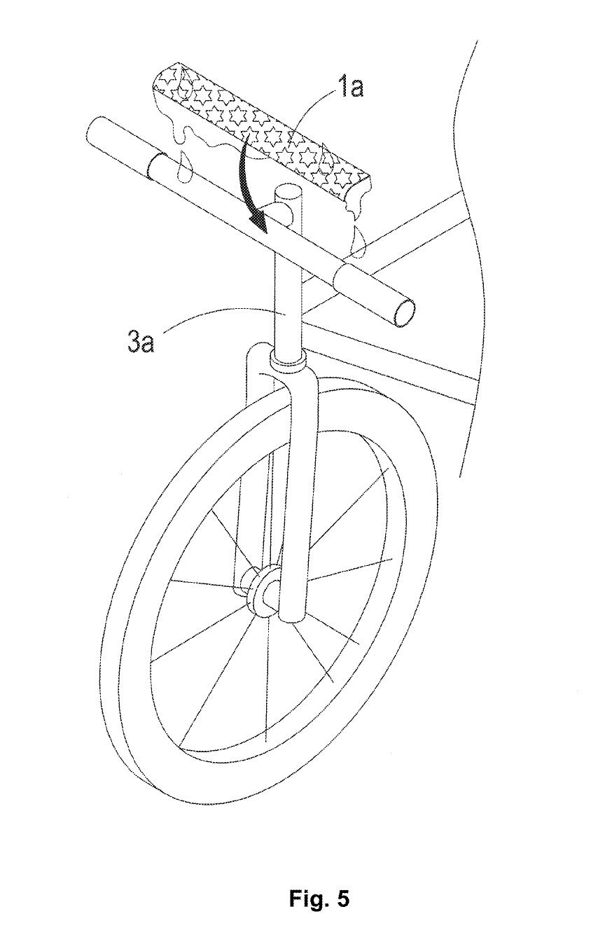

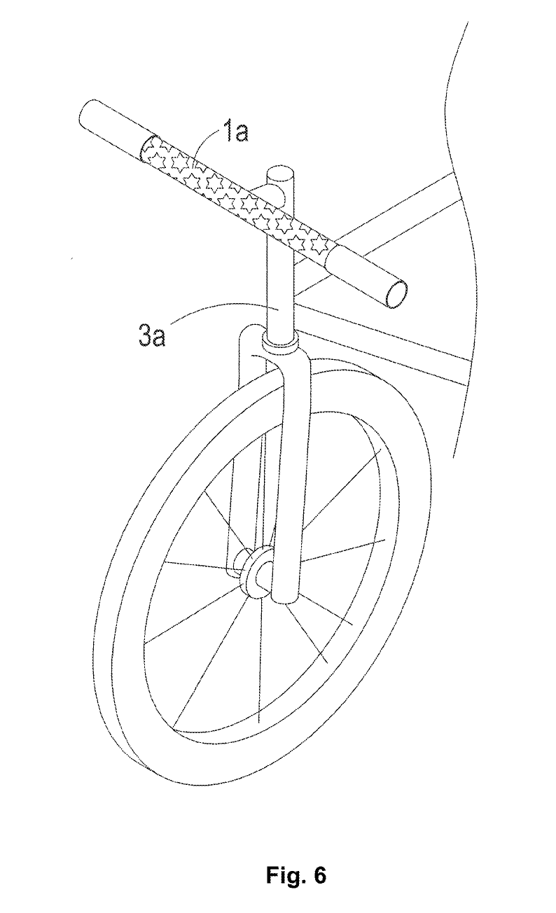

Please refer to FIG. 5 and FIG. 6. FIG. 5 is a state drawing showing when the non-detachable reflective structure has just been applied and the essential oil has not yet dissolved according to the present invention. FIG. 6 is a state drawing showing when the non-detachable reflective structure has just been applied and the essential oil has dissolved according to the present invention. As shown in FIG. 6, taking a typical bicycle frame 3a as an example of an object having a complicated curved surface, when the user wants to apply the detachable reflective layer 11a onto the bicycle frame 3a surface, he or she wets the substrate 10a with water and applies it onto the bicycle frame 3a surface. Subsequently, the isolation layer 20 (the essential oil) dissolves in the water and then evaporates with the water. Since the ink layer 30a disposed over the isolation layer 20a is a material having a low ductility, the cover layer 50a placed over the ink layer 30a is used to provide better ductility. Because the cover layer 50a is made from a resin material, when the cover layer 50a covers the ink layer 30a surface, the total ductility of the ink layer 30a is improved. Additionally, the cover layer 50a surface uses the cross linking agent 32a as a medium so that the reflective effects of the glass bead layer 40a is able to placed over the cover layer 50a. Therefore, the glass bead layer 40a placed over the cover layer 50a is the very outside layer, and when light illuminates onto the glass bead layer 40, a reflective effect is generated to improve nighttime safety for the user. In addition, since the ink layer 30a is capable of supporting inks with different colors, each of which may correspond to a different figure, the appearance of the bicycle frame 3a in daytime may also be improved visually.

Although the present invention has been explained in relation to its preferred embodiment, it is to be understood that many other possible modifications and variations can be made without departing from the spirit and scope of the invention as hereinafter claimed.

What is claimed is:

1. An improved reflective structure comprising:
a substrate for adhesion onto an object;
an isolation layer disposed over the substrate separated from the object and dissolvable in water;
an ink layer having a high polymer content and printed onto the surface of the isolation layer;
a glass bead layer capable of reflecting light and disposed onto the ink layer surface; and
a cover layer disposed over the surface of the glass bead layer, the cover layer insoluble in water and detachable from the glass bead layer.

2. The improved reflective structure as claimed in claim 1, wherein the isolation layer is an essential oil.

3. The improved reflective structure as claimed in claim 1, wherein the ink layer includes inks having different colors.

4. The improved reflective structure as claimed in claim 1, wherein the glass bead layer comprises a cross linking agent as a medium to cover the ink layer.

5. The improved reflective structure as claimed in claim 1, wherein the cover layer is a resin material insoluble in the ink layer.

6. An improved reflective structure utilizing a water transfer printing means for adhesion onto an object in a non-detachable manner, the structure comprising:
a substrate for adhesion onto an object;
an isolation layer disposed over the substrate surface separated from the object and dissolvable in water;
an ink layer having a high polymer content and printed onto the surface of the isolation layer;
a cover layer disposed over the surface of a glass bead layer, the cover layer insoluble in the ink layer and capable of being deformed with the substrate; and
a glass bead layer capable of reflecting light and disposed onto the cover layer surface.

7. The improved reflective structure as claimed in claim 6, wherein the isolation layer is an essential oil.

8. The improved reflective structure as claimed in claim 6, wherein the ink layer includes a plurality of different colored inks.

9. The improved reflective structure as claimed in claim 6, wherein the glass bead layer comprises a cross linking agent as a medium to cover the ink layer.

10. The improved reflective structure as claimed in claim 6, wherein the cover layer is a resin material insoluble in the ink layer.
